(19) United States
(12) Patent Application Publication
(10) Pub. No.: US 2022/0130196 A1
(43) Pub. Date: Apr. 28, 2022

(54) MONEY HANDLING APPARATUS AND MONEY HANDLING METHOD

(71) Applicant: Glory Ltd., Himeji-shi (JP)

(72) Inventor: Yasuhiro Matsumoto, Himeji-shi (JP)

(73) Assignee: Glory Ltd., Himeji-shi (JP)

(21) Appl. No.: 17/506,691

(22) Filed: Oct. 21, 2021

(30) Foreign Application Priority Data
Oct. 26, 2020 (JP) 2020-179095

(51) Int. Cl. G07C 9/00; G07F 17/10; G07C 9/32; G07D 11/125; G07D 11/40; E05G 1/08

(52) U.S. Cl. CPC G07C 9/00912; G07F 17/105; G07C 9/32; E05G 1/08; G07D 11/125; G07D 11/40; G07C 9/00571

(57) ABSTRACT

A money handling apparatus includes: a safe having a safe door; a plurality of drawers configured to be drawable from the safe when the safe door is opened, each drawer including one or a plurality of storage units configured to store money therein; at least one locking unit configured to restrict drawing-out of each drawer from the safe; and a control unit configured to control the at least one locking unit to put each drawer into either an unlocked state where drawing-out of the drawer is allowed or a locked state where drawing-out of the drawer is restricted.

### CROSS-REFERENCE TO RELATED APPLICATION

The present application is based on and claims priority to Japanese Patent Application No. 2020-179095 filed Oct. 26, 2020, the entire contents of which being incorporated herein by reference.

### TECHNICAL FIELD

The present disclosure relates to a money handling apparatus and a money handling method for handling money.

### BACKGROUND ART

Conventionally, money handling apparatuses for handling money have been used in various places. For example, PCT International Publication WO/2010-109606 discloses a money handling apparatus including safes. The money handling apparatus is used in a store to handle money. Also, the money handling apparatus is used by a cash-in-transit (CIT) company when the CIT company collects money from the store. Therefore, the money handling apparatus includes two safes, i.e., a safe for the store and a safe for the CIT company. A storage unit for storing money therein is disposed inside each safe. In the safe for the store, the storage unit is used for storing money to be used in the store. In the safe for the CIT company, the storage unit is used for storing money to be collected from the store by the CIT company.

The money stored in the storage unit can be taken out of the safe by unlocking and opening a door of the safe and drawing out the storage unit from the safe. A clerk of the store can unlock the door of the safe for the store, but cannot unlock the door of the safe for the CIT company. Meanwhile, a person of the CIT company can unlock the door of the safe for the CIT company, but cannot unlock the door of the safe for the store. The money handling apparatus includes the plurality of safes, so that the number of storage units that can be drawn out from the safes can be limited, among the plurality of storage units included in the money handling apparatus.

### SUMMARY

In the above conventional art, the two safes, i.e., the safe for the store and the safe for the CIT company, need to be separately disposed in the money handling apparatus. It leads to a complicated structure of the money handling apparatus and, it causes an increase in manufacturing cost and an increase in weight.

The present disclosure is made in view of the conventional art having the above problem. The present disclosure addresses the problem, as discussed herein, with a money handling apparatus and a money handling method capable of limiting a storage unit that can be drawn out from a safe, among a plurality of storage units disposed inside the safe of the money handling apparatus.

A money handling apparatus according to one aspect of the present disclosure includes: a safe having a safe door; a plurality of drawers configured to be drawable from the safe when the safe door is opened, each drawer including one or a plurality of storage units configured to store money therein; at least one locking unit configured to restrict drawing-out of each of the plurality of drawers from the safe; and a control unit configured to control the at least one locking unit to put each drawer into either an unlocked state where drawing-out of the drawer is allowed or a locked state where drawing-out of the drawer is restricted. The objects, features, advantages and technical and industrial significance of this disclosure will be better understood by the following description and the accompanying drawings of the disclosure.

### BRIEF DESCRIPTION OF THE DRAWINGS

FIG. 1 is a schematic diagram illustrating the structure of a money handling apparatus according to an embodiment of the present disclosure;

FIG. 2 is a schematic diagram illustrating a method of taking out money from the money handling apparatus;

FIG. 3 is an external view of the money handling apparatus;

FIG. 4 is a schematic diagram illustrating the structure of the money handling apparatus shown in FIG. 3;

FIG. 5 is an external view of a part of a safe in the money handling apparatus; and

FIG. 6 is a flowchart illustrating the flow of a process in which a drawer is drawn out from a safe.

### DESCRIPTION OF EMBODIMENTS

Hereinafter, an embodiment of a money handling apparatus and a money handling method according to the present disclosure will be described with reference to the drawings. The money handling apparatus according to the present embodiment includes at least one safe. A plurality of drawers are disposed in each safe. Each drawer is configured so as to be drawn out from the safe when a door of the safe is opened. Each drawer includes one or a plurality of storage units. Each storage unit is configured to store money therein. The money described in the present disclosure includes at least either banknotes or coins. Each drawer is configured so as to be independently locked by a locking unit. The drawer locked by the locking unit cannot be drawn out from the safe. In the money handling apparatus, each drawer can be set to either a locked state or an unlocked state. In the locked state, the drawer is locked by the locking unit and restricted from being drawn out from the safe. In the unlocked state, the drawer is released from the locking unit and allowed to be drawn out from the safe. For example, each drawer is usually locked by the locking unit. At least one drawer is unlocked according to the type of a user of the money handling apparatus, and becomes drawable from the safe. For another example, at least one drawer is unlocked according to the type of money handling process to be performed by the money handling apparatus, and becomes drawable from the safe. The user of the money handling apparatus can unlock and open the safe door, and draw out the unlocked drawer from the safe.

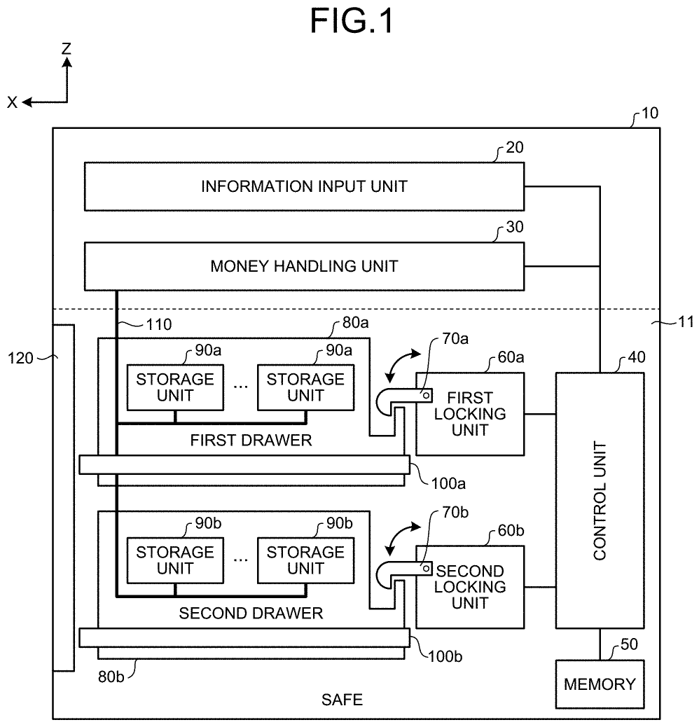

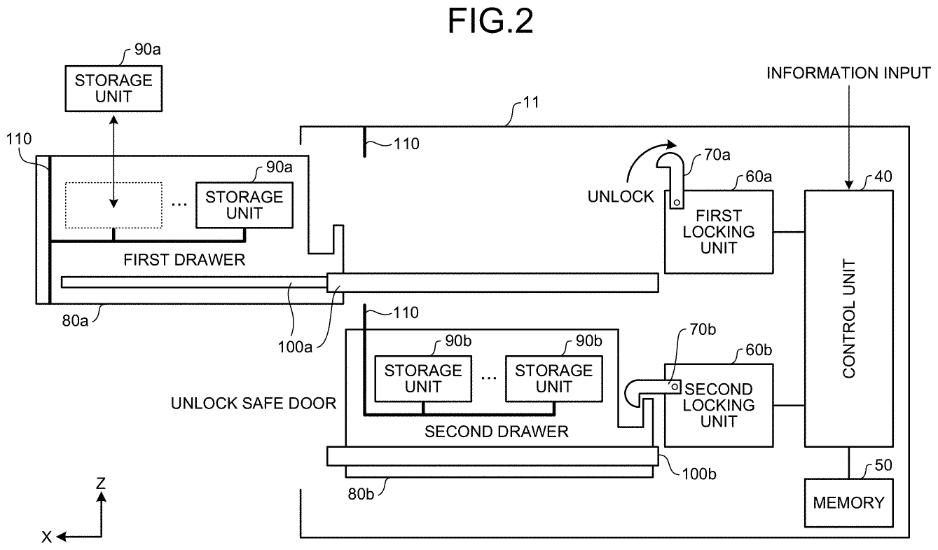

FIG. 1 is a schematic diagram illustrating the structure of a money handling apparatus 10 according to the present embodiment. FIG. 2 is a schematic diagram illustrating a method of taking out money from the money handling apparatus 10. In the figures illustrating the structure of the money handling apparatus 10, coordinate axes are shown such that the correspondence between each figure can be understood. In the coordinate axes, the Z-axis positive direction is the upper direction. A surface in the X-axis positive direction is the front surface of the money handling apparatus 10. The right side as viewed from the user using the money handling apparatus 10 from the front surface side is the Y-axis positive direction.

As shown in FIG. 1, the money handling apparatus 10 includes an information input unit 20, a money handling unit 30, a control unit 40, a memory 50, a plurality of locking units 60 (60a, 60b), a plurality of drawers 80 (80a, 80b), and a transport unit 110. Although two drawers 80, i.e., a first drawer 80a and a second drawer 80b, are shown in FIG. 1, the number of drawers 80 is not particularly limited, and may be three or more.

Each drawer 80 is provided with storage units 90 (90a, 90b). Each storage unit 90 is used for storing therein money handled in the money handling unit 30. The number of storage units 90 disposed in each drawer 80 is not particularly limited. One or a plurality of storage units 90a are disposed in the first drawer 80a, and one or a plurality of storage units 90b are disposed in the second drawer 80b. For example, the storage unit 90 may be fixed to the drawer 80. For another example, the storage unit 90 may be a storage container that is detachable with respect to the drawer 80. Alternatively, the storage unit 90 may store money in a storage container that is detachable from the storage unit 90.

The money handling apparatus 10 includes a safe 11. The control unit 40, the memory 50, the locking units 60, the drawers 80, the storage units 90, and a part of the transport unit 110 are disposed inside the safe 11. A slit-like opening is formed at an upper surface of the safe 11. Money being transported by the transport unit 110 can pass through the opening, but a person's hand cannot be inserted into the safe 11 from the opening. The transport unit 110 can transport the money handled by the money handling unit 30 from the opening into the safe 11. In the safe 11, the money transported by the transport unit 110 can be stored in any of the plurality of storage units 90.

The safe 11 has a safe door 120 that is locked by a locking/unlocking unit. After the safe door 120 is unlocked by the locking/unlocking unit and opened, the drawer 80 can be drawn out from the safe 11, i.e., the money handling apparatus 10 as shown in FIG. 2. For example, an electronic lock is used as the locking/unlocking unit for the safe door 120. However, the structure of the locking/unlocking unit is not particularly limited. The safe door 120 may be locked and unlocked mechanically by inserting a locking/unlocking key into a keyhole.

For example, the drawer 80 and the safe 11 are connected to each other by slide rails 100 (100a, 100b). The drawer 80 is supported by the slide rails 100 at the left and right side surfaces thereof. Each slide rail 100 has a multistage rail structure in which a plurality of rails are connected. When the drawer 80 is to be drawn from the safe 11 toward the apparatus front side (in the X-axis positive direction), the safe door 120 is opened and locking of the drawer 80 by the locking unit 60 is released. Then, the drawer 80 fixed to inner rails of the slide rail 100 moves with the inner rails frontward with respect to outer rails fixed to the safe 11, as shown in FIG. 2. As a result, the drawer 80 is drawn out from the safe 11. The structure of the drawer 80 is not particularly limited as long as the drawer 80 can be drawn out from the safe 11. For example, the drawer 80 may be provided with rollers and drawn out with the rollers being rotated. Also, the position at which the drawer 80 is supported is not particularly limited. The drawer 80 may be hung inside the safe 11, or the bottom surface of the drawer 80 may be supported inside the safe 11. All the drawers 80 in the safe 11 may not necessarily have the same structure. The drawers 80 may have different structures to realize different supporting methods and/or different drawing methods in the safe 11.

The locking unit 60 (60a, 60b) includes a locking mechanism 70 (70a, 70b). The locking unit 60 controls the locking mechanism 70 to lock the drawer 80 such that the drawer 80 cannot to be drawn out from the safe 11, and unlock the drawer 80 such that the drawer 80 can be drawn out from the safe 11.

For example, the locking unit 60 causes the hook-shaped locking mechanism 70 to pivot as shown by an arrow in FIG. 1. When a hook portion of the locking mechanism 70 is engaged with a locking groove formed in the drawer 80 as shown in FIG. 1, the drawer 80 is locked so as not to be drawable. That is, the drawer 80 is restricted from being drawn out from the safe 11. When the hook portion of the locking mechanism 70 moves away from the locking groove of the drawer 80 as shown by an arrow in FIG. 2, the drawer 80 is unlocked and becomes drawable. That is, the drawer 80 is allowed to be drawn out from the safe 11 when the drawer 80 is unlocked by the locking unit 60. The locking method for the drawer 80 is not particularly limited as long as each drawer 80 can be independently locked and unlocked. For example, the locking unit 60 may insert a rod into a hole formed in the drawer 80 such that a position of the drawer 80 is fixed and the drawer 80 is locked. The locking method is not limited to the method in which the locking unit 60 mechanically locks the drawer 80. For example, the drawer 80 may be locked by using an electromagnetic lock. Also, the number of the locking units 60 is not particularly limited, and the locking units 60 as many as the drawers 80 may not necessarily be disposed in the safe 11. For example, one locking unit 60 may control the locking and unlocking operations of the plurality of locking mechanisms 70.

The money handling unit 30 can handle money to be stored in the storage unit 90 in the safe 11. For example, the money handling unit 30 includes an inlet that receives money from the outside of the money handling apparatus 10. The money received at the inlet of the money handling unit 30 is transported into the safe 11 by the transport unit 110 and stored in the storage unit 90. The structure of the money handling unit 30 is not particularly limited. For example, the money handling unit 30 may include a recognition unit that recognizes and counts money, and the money received at the inlet may be recognized and counted by the recognition unit. Moreover, for example, the money handling unit 30 may include an outlet that discharges money from the money handling apparatus 10, and the money that has been fed out from the storage unit 90 in the safe 11 and transported by the transport unit 110 may be discharged from the outlet.

The information input unit 20 inputs, to the control unit 40, information related to money handling to be performed in the money handling apparatus 10. The information input unit 20 receives information from the user of the money handling apparatus 10, and inputs information corresponding to the received information to the control unit 40. For example, the information input unit 20 may be a touch-panel type input device or an input device having a plurality of keys. For another example, the information input unit 20 may be a reading device that optically, electronically, or magnetically reads information from a medium such as a card, or may be a communication device that receives information through wired communication or wireless communication. The information input unit 20 may not necessarily be included in the money handling apparatus 10, and may be disposed independently from the money handling apparatus 10.

The memory 50 is a nonvolatile memory device. Various kinds of information necessary for the operation of the money handling apparatus 10 are stored in the memory 50. For example, a setting information is stored in the memory 50. In the setting information, one or a plurality of drawers 80 to be unlocked by the locking unit 60 under control of the control unit 40 when the information is inputted from the information input unit 20 are set for each piece of information that can be inputted by using the information input unit 20. That is, the setting information indicating correspondence between the kind of information inputted from the information input unit 20 and the drawer(s) 80 to be made drawable from the safe 11, is stored in the memory 50.

Upon receiving information inputted from the information input unit 20, the control unit 40 specifies a drawer 80 to be made drawable from the safe 11, with reference to the setting information in the memory 50. The control unit 40 controls the locking unit 60 to unlock the specified drawer 80. The user of the money handling apparatus 10 can change the drawer 80 to be made drawable from the safe 11 among the plurality of drawers 80, by changing the information to be inputted to the information input unit 20.

For example, setting information, in which identification information of each of a plurality of users using the money handling apparatus 10 is associated with information on a drawer 80 to be made drawable from the safe 11, is stored in the memory 50 in advance. The control unit 40 refers to the setting information stored in the memory 50, based on identification information inputted from the information input unit 20, and unlocks the drawer 80 associated with the identification information.

For example, it is assumed that the storage unit 90a of the first drawer 80a shown in FIG. 1 is assigned to a store where the money handling apparatus 10 is installed, and the storage unit 90b of the second drawer 80b is assigned to a CIT company that collects money from the store to convey the money to a financial institution. In this case, setting information, in which identification information of a store clerk is associated with the first drawer 80a while identification information of a person of the CIT company is associated with the second drawer 80b, is stored in the memory 50 in advance.

When the store clerk has inputted the identification information to the information input unit 20, the control unit 40 receives the inputted identification information. The control unit 40 refers to the setting information in the memory 50, and recognizes that the identification information is associated with the first drawer 80a. The control unit 40 controls the first locking unit 60a to unlock the first drawer 80a while the second drawer 80b remains locked by the second locking unit 60b as shown in FIG. 2. As a result, only the first drawer 80a, of the two drawers 80, becomes drawable from the safe 11.

The store clerk can unlock and open the safe door 120, and draw out the first drawer 80a from the safe 11 as shown in FIG. 2. For example, the store clerk can take out money from the storage unit 90a fixed to the first drawer 80a in order to collect the money from the money handling apparatus 10, and/or the store clerk can replenish the storage unit 90a with money. For another example, when jamming of money occurs in a transport path in the first drawer 80a, the store clerk can draw out the first drawer 80a from the safe 11 and remove the jammed money.

When the CIT person has inputted the identification information to the information input unit 20, the control unit 40 receives the inputted identification information. The control unit 40 refers to the setting information in the memory 50, and controls the second locking unit 60b to unlock the second drawer 80b while the first drawer 80a remains locked by the first locking unit 60a. As a result, only the second drawer 80b, of the two drawers 80, becomes drawable from the safe 11. The CIT person can unlock and open the safe door 120, draw out the second drawer 80b from the safe 11, and collect money from the storage unit 90b. For example, the CIT person may dismount the detachable cassette-type storage unit 90b from the second drawer 80b to collect money stored in the storage unit 90b together with the storage unit 90b, and mount another empty storage unit 90b to the second drawer 80b instead of the dismounted storage unit 90b.

For example, setting information, in which each of a plurality of types of money handling processes to be performed in the money handling apparatus 10 is associated with a drawer 80 to be made drawable from the safe 11, is stored in the memory 50 in advance. When information indicating a type of a money handling process is inputted through the information input unit 20, the control unit 40 refers to the setting information in the memory 50, based on the inputted information, and controls the locking unit 60 to unlock the drawer 80 associated with the type of the money handling process.

For example, setting information, in which a replenishment process of manually replenishing the storage unit 90a with money by the store clerk is associated with the first drawer 80a while a collection process of collecting money from the storage unit 90b by the CIT person is associated with the second drawer 80b, is stored in the memory 50 in advance. When the store clerk inputs, to the information input unit 20, information indicating start of the replenishment process, the control unit 40 unlocks the first drawer 80a. The store clerk can unlock and open the safe door 120, draw out the first drawer 80a from the safe 11, and replenish the storage unit 90a with money. Meanwhile, when the CIT person inputs, to the information input unit 20, information indicating start of the collection process, the control unit 40 unlocks the second drawer 80b. The CIT person can unlock and open the safe door 120, draw out the second drawer 80b from the safe 11, and collect money from the storage unit 90b.

After completing operations for the drawer 80 drawn out from the safe 11, the drawer 80 is pushed into the safe 11 to close the drawer 80. For example, the control unit 40 detects the drawer 80 pushed into the safe 11 by using the detector disposed inside the safe 11. Upon detecting the closed drawer 80, the control unit 40 controls the locking unit 60 to lock the drawer 80 so that the drawer 80 becomes not drawable from the safe 11. The locking of the drawer 80 after having been returned into the safe 11 may not necessarily be performed by detecting the closed drawer 80. For example, the drawer 80 may be locked upon detecting that the safe door 120 is closed. For another example, the drawer 80 may be locked upon detecting that the store clerk or the CIT person has inputted, to the information input unit 20, information indicating completion of the money handling process.

The number of drawers 80 to be made drawable from the safe 11 according to the information inputted from the information input unit 20 is not particularly limited. In response to one piece of inputted information, one drawer 80 or a plurality of drawers 80 may be made drawable.

As described above, the money handling apparatus 10 can select one or a plurality of drawers 80 from among a plurality of drawers 80 disposed in one safe 11 to make the selected drawers 80 drawable from the safe 11. That is, the money handling apparatus 10 can set each of the plurality of drawers 80 to either a state where the drawer 80 is restricted from being drawn out from the safe 11, or a state where the drawer 80 is allowed to be drawn out from the safe 11. The money handling apparatus 10 can change the drawer 80 to be made drawable, according to the type of the user. Moreover, the money handling apparatus 10 can change the drawer 80 to be made drawable, according to the type of the money handling process.

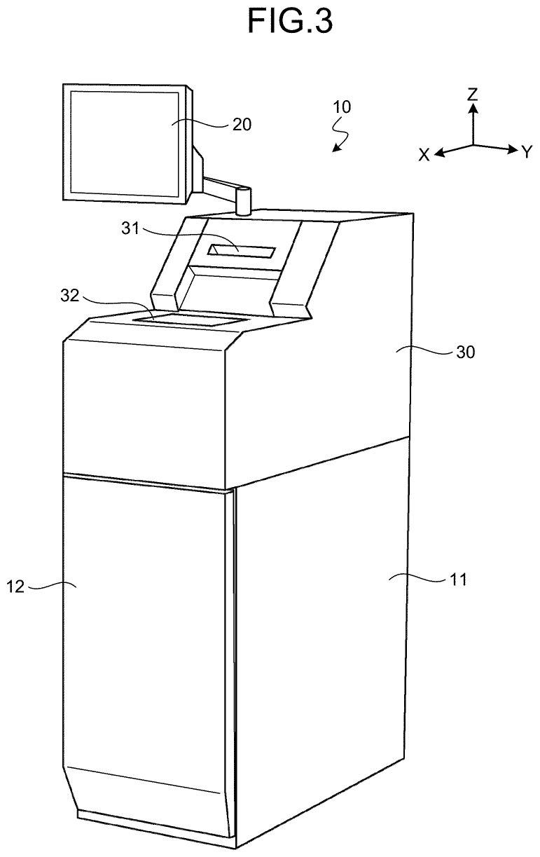

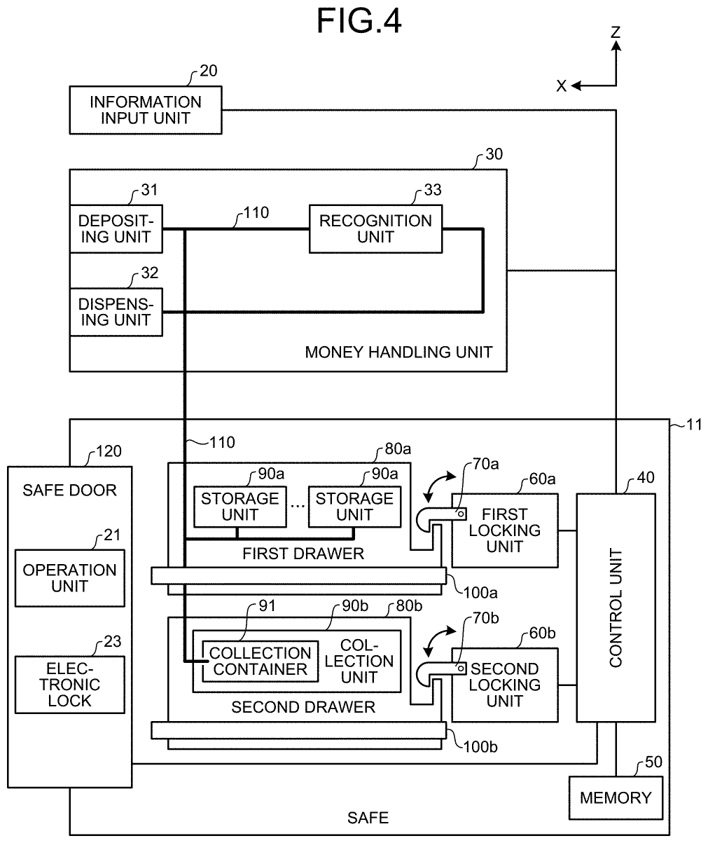

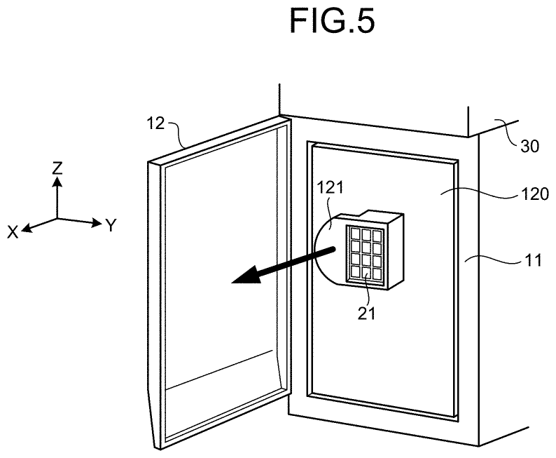

Next, a specific example of the money handling apparatus 10 installed in the store will be described. FIG. 3 is an external view of the money handling apparatus 10. FIG. 4 is a schematic diagram illustrating the structure of the money handling apparatus 10 shown in FIG. 3. FIG. 5 is an external view of a part of the safe 11 in the money handling apparatus 10. Hereinafter, the money handling apparatus 10 shown in FIG. 3 to FIG. 5 will be described mainly for points different from FIG. 1 and FIG. 2.

As shown in FIG. 3, the money handling apparatus 10 has a structure in which the money handling unit 30 and the safe 11 are integrated with each other. The information input unit 20 is disposed on the upper surface of the money handling unit 30. The information input unit 20 is a touch-panel type liquid crystal display device. The information input unit 20 functions as an operation unit through which information related to a money handling process is inputted, and also functions as a display unit that displays information related to a money handling process on a screen. The money handling unit 30 is provided with a depositing unit 31 that receives money to be deposited in the money handling apparatus 10, and a dispensing unit 32 to which money to be dispensed from the money handling apparatus 10 is discharged.

A cover 12 that hides the safe door 120 is disposed at the front surface of the safe 11. When the cover 12 is opened, the safe door 120 appears as shown in FIG. 5. The safe door 120 is provided with an operation unit 21 for unlocking an electronic lock 23 that locks and unlocks the safe door 120.

The control unit 40 can control whether or not to receive an input from the operation unit 21 of the safe door 120. In a situation where the safe door 120 need not be opened, even if an unlock code is inputted by operating the plurality of keys of the operation unit 21, the control unit 40 does not receive the inputted code and therefore, the safe door 120 cannot be opened. When the safe door 120 needs to be opened, the control unit 40 receives the unlock code inputted through the operation unit 21.

When the unlock code inputted through the operation unit 21 to the control unit 40 is correct, the control unit 40 controls the electronic lock 23 to unlock the safe door 120. When a handle 121 is pulled frontward as shown by an arrow in FIG. 5 after the safe door 120 is unlocked, the safe door 120 is opened. The safe door 120 having hinges on a right side surface thereof opens by pivoting around the hinges. When the safe door 120 is closed, the safe door 120 is locked again automatically by using the electronic lock 23.

As shown in FIG. 4, a recognition unit 33 that recognizes and counts money is disposed in the housing of the money handling unit 30. The depositing unit 31, the dispensing unit 32, and the recognition unit 33 are connected to each other by a transport path. The transport unit 110 can transport money along the transport path between these units 31 to 33. The transport path in the money handling unit 30 is connected to the transport path in the safe 11, so that the transport unit 110 can transport money between the money handling unit 30 and the storage unit 90 in the safe 11. A plurality of detectors for detecting money being transported along the transport path are disposed at a plurality of positions along the transport path. When jamming of money occurs in the transport path, the control unit 40 can detect the position of the jamming by using the detectors.

The first drawer 80a is provided with a plurality of storage units 90a that store therein money by type. For example, money is stored for each denomination in the plurality of storage units 90a. The second drawer 80b is provided with a storage unit 90b that stores therein money to be collected from the money handling apparatus 10. The storage unit 90b functions as a collection unit that stores money into a collection container 91 detachably mounted to the storage unit 90b. For example, money collected from the storage unit 90a is stored in the collection container 91 by the storage unit 90b. For example, the collection container 91 is a bag-like container capable of storing therein a large quantity of money.

When the store clerk starts a depositing process by operating the information input unit 20, money placed in the depositing unit 31 by the store clerk is fed into the money handling apparatus 10 one by one. The transport unit 110 transports the money fed into the money handling apparatus 10. Inside the money handling apparatus 10, the money is transported along the transport path, and the recognition unit 33 can recognize and count the money being transported. The transport unit 110 can transport the money to the storage unit 90a or the storage unit 90b in the safe 11, based on the result of recognition by the recognition unit 33. For example, money that can be stored in the storage units 90a is stored in a storage unit 90a corresponding to the type of the money among the plurality of storage units 90a. Money that is not stored in the storage units 90a is transported to the storage unit 90b and stored in the collection container 91.

The storage unit 90b of the second drawer 80b stores money in the collection container 91, but does not feed out money. Meanwhile, the storage unit 90a of the first drawer 80a can feed out money stored therein, onto the transport path. The money handling apparatus 10 can perform a dispensing process by using the money fed out from the storage units 90a.

When the store clerk starts the dispensing process by operating the information input unit 20, money to be dispensed is successively fed out from the storage unit 90a one by one. The fed-out money is transported by the transport unit 110 from the safe 11 to the money handling unit 30, and dispensed from the dispensing unit 32.

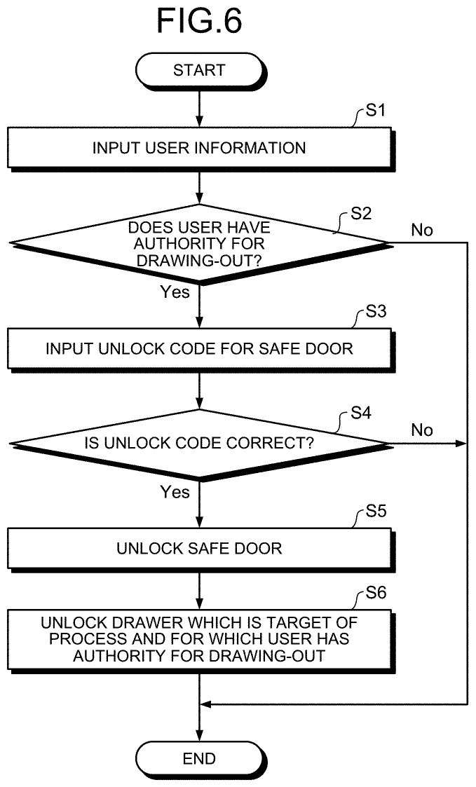

FIG. 6 is a flowchart showing the flow of a process in which a drawer 80 is drawn from the safe 11. For example, if jamming of money occurs in the transport path near the storage unit 90a while the money handling apparatus 10 performs a money handling process, the store clerk starts an operation of drawing out the first drawer 80a from the safe 11 to eliminate the jamming of money.

The store clerk inputs his/her identification information to the information input unit 20 (step S1) to start an error elimination process for eliminating jamming of money. The control unit 40 can detect the jamming of money occurred in the transport path in the first drawer 80a by the detectors disposed at a plurality of positions along the transport path. When the error elimination process is started, the control unit 40 refers to the setting information in the memory 50, and determines whether or not the store clerk has authority to draw out, from the safe 11, the first drawer 80a to be subjected to the error elimination process (step S2). The setting information, in which the identification information of the store clerk is associated with various types of authorities, is stored in the memory 50 in advance. The determination is performed based on the setting information.

When the store clerk does not have authority to draw out the first drawer 80a (step S2; No), the control unit 40 notifies the store clerk that he/she does not have the authority, and ends the process. For example, the notification is performed by displaying an error screen on the information input unit 20. In this case, even if the store clerk inputs the unlock code by operating the operation unit 21 of the safe door 120, the safe door 120 cannot be opened.

On the other hand, when the store clerk has authority to draw out the first drawer 80a (step S2; Yes), the control unit 40 displays, on the information input unit 20, information instructing the store clerk to perform an unlocking operation with the operation unit 21 of the safe door 120.

The store clerk opens the cover 12 as shown in FIG. 5, and inputs the unlock code to the operation unit 21 of the safe door 120. Then, the control unit 40 determines whether or not the inputted unlock code is correct (step S4). If the unlock code is wrong (step S4; No), the control unit 40 ends the process without opening the safe door 120.

When the unlock code inputted to the operation unit 21 is correct (step S4; Yes), the control unit 40 controls the electronic lock 23 to unlock the safe door 120 (step S5). Also, the control unit 40 controls the first locking unit 60a to unlock the first drawer 80a in which jamming of money is detected (step S6), and ends the process.

The store clerk can open the safe door 120, draw out the unlocked first drawer 80a from the safe 11, and remove the money jammed in the transport path in the first drawer 80a. After removing the money jammed in the transport path, the store clerk pushes the first drawer 80a into the safe 11 to close the first drawer 80a. Thereafter, the control unit 40 controls the first locking unit 60a to lock the closed first drawer 80a.

During the operation of eliminating jamming of money in the first drawer 80a, the second drawer 80b is locked by the second locking unit 60b. Since the store clerk cannot draw out the second drawer 80b from the safe 11, money stored in the collection container 91 in the storage unit 90b cannot be taken out therefrom.

When the CIT person performs the collection process to collect money stored in the collection container 91 from the store, the CIT person needs to draw out, from the safe 11, the second drawer 80b including the collection container 91. The CIT person inputs the identification information to the information input unit 20 (step S1) to start the money collection process. The control unit 40 refers to the information stored in the memory 50, and determines whether or not the CIT person has authority to draw out the second drawer 80b including the collection container 91 (step S2) from the safe 11. The setting information, in which the identification information of the CIT person is associated with various types of authorities, is stored in the memory 50 in advance. The determination is performed based on the setting information.

When the CIT person does not have authority to draw out the second drawer 80b (step S2; No), the control unit 40 displays an error screen on the information input unit 20, and ends the process. In this case, even if the CIT person inputs the unlock code by operating the operation unit 21 of the safe door 120, the safe door 120 cannot be opened.

On the other hand, when the CIT person has the authority to draw out the second drawer 80b (step S2; Yes), the control unit 40 displays, on the screen of the information input unit 20, information instructing the CIT person to perform an unlocking operation with the operation unit 21 of the safe door 120.

The CIT person opens the cover 12 as shown in FIG. 5, and inputs the unlock code to the operation unit 21 of the safe door 120. Then, the control unit 40 determines whether or not the inputted unlock code is correct (step S4). If the unlock code is wrong (step S4; No), the control unit 40 ends the process without opening the safe door 120.

When the unlock code inputted through the operation unit 21 is correct (step S4; Yes), the control unit 40 controls the electronic lock 23 to unlock the safe door 120 (step S5). Also, the control unit 40 controls the second locking unit 60b to unlock the second drawer 80b (step S6), and ends the process.

The CIT person can open the safe door 120, draw out the unlocked second drawer 80b from the safe 11. The CIT person can dismount, from the storage unit 90b, the collection container 91, in which money to be collected is being stored, to collect the money from the store. Then, the CIT person mounts an empty collection container 91 to the storage unit 90b, and pushes the second drawer 80b into the safe 11 to close the second drawer 80b. Thereafter, the control unit 40 controls the second locking unit 60b to lock the closed second drawer 80b.

The first drawer 80a is locked by the first locking unit 60a while the collection container 91 is collected from the second drawer 80b. Since the CIT person cannot draw out the first drawer 80a from the safe 11, money stored in the storage unit 90a cannot be taken out therefrom.

It is assumed that the money handling apparatus 10 includes three or more drawers 80 and it is determined, in step S2, there are two or more drawers 80 for which the store clerk or the CIT person has authority to draw them out from the safe 11. In this case, among these drawers 80 for which the authority is given to the store clerk or the CIT person, only the drawer 80 to be subjected to the ongoing process is unlocked in step S6.

For example, in the error elimination process of eliminating jamming of money, even if there are two or more drawers 80 for which the store clerk has authority to draw them out from the safe 11, only the drawer 80 in which jamming of money is detected is unlocked while other drawers 80 remain locked. Likewise, in the collection process of collecting money from the money handling apparatus 10, even if there are two or more drawers 80 for which the CIT person has authority to draw them out from the safe 11, only the drawer 80 in which money to be collected is stored is unlocked while other drawers 80 remain locked.

Although FIG. 6 shows the case where the control unit 40 controls the electronic lock 23 to open the safe door 120, the control unit 40 may not necessarily control the electronic lock 23. In a case where the control unit 40 does not control the electronic lock 23, the processes in steps S3 to S5 are omitted from FIG. 6.

In the examples described in the present embodiment, the drawers 80 are usually locked in the safe 11 whose safe door 120 is closed, and the drawer 80 to be drawn out from the safe 11 is unlocked when the safe door 120 is opened. However, the locking method for the drawers 80 is not limited thereto. For example, the drawers 80 may be unlocked in the safe 11 while the safe door 120 is closed. In this case, when the safe door 120 is opened to draw out a target drawer 80, non-target drawers 80, which are not to be drawn out from the safe 11, become locked while the target drawer 80 remains unlocked.

As described above, the money handling apparatus according to the present embodiment includes, in one safe, a plurality of drawers that are drawable from the safe, and money can be stored in one or a plurality of storage units disposed in each drawer. The money handling apparatus recognizes a drawer required to be drawn out from the safe, and unlocks the drawer to allow drawing-out from the safe. Meanwhile, the money handling apparatus locks the other drawer to restrict drawing-out from the safe. Since the money handling apparatus can limit a drawer that can be drawn out from the safe when the safe door is opened, it is possible to ensure security for money stored in the storage units in the drawers.

In the present disclosure, a money handling apparatus includes: a safe having a safe door; a plurality of drawers configured to be drawable from the safe when the safe door is opened, each drawer including one or a plurality of storage units configured to store money therein; at least one locking unit configured to restrict drawing-out of each of the plurality of drawers from the safe; and a control unit configured to control the at least one locking unit to put each drawer into either an unlocked state where drawing-out of the drawer is allowed or a locked state where drawing-out of the drawer is restricted.

In the above configuration, the control unit controls the at least one locking unit while the safe door is opened, such that at least one drawer, among the plurality of drawers, is allowed to be drawn out from the safe while other drawers are not allowed to be drawn out from the safe.

In the above configuration, the money handling apparatus further includes: an information input unit an information input unit through which information on money handling is inputted to the control unit; and a memory that stores setting information prepared in advance, the setting information including drawer information that has been prepared for each piece of information to be inputted through the information input unit, and the drawer information indicating at least one drawer to be made drawable from the safe when the each piece of information is inputted through the information input unit. When the information has been inputted through the information input unit, the control unit specifies, based on the setting information, the at least one drawer to be made drawable and controls the at least one locking unit to allow the specified at least one drawer to be drawn out from the safe.

In the above configuration, the information on money handling includes identification information of a user, and the setting information includes the drawer information prepared for each piece of the identification information. When the identification information of the user has been inputted through the information input unit, the control unit specifies, based on the setting information, the at least one drawer that can be made drawn out by the user having the inputted identification information, and controls the at least one locking unit to allow the specified at least one drawer to be drawn out from the safe.

In the above configuration, the information on money handling includes type information indicating a type of the money handling performed in the money handling apparatus, and the setting information includes the drawer information prepared for each piece of the type information. When the type information has been inputted through the information input unit, the control unit specifies, based on the setting information, the at least one drawer that can be drawn out in the money handling whose type is indicated by the inputted type information, and controls the at least one locking unit to allow the specified at least one drawer to be drawn out from the safe.

In the above configuration, the money handling apparatus further includes: a locking/unlocking unit configured to lock and unlock the safe door; and an operation unit through which an unlock code for unlocking the safe door by the locking/unlocking unit is inputted. The operation unit accepts an input of the unlock code on condition that there is the at least one drawer to be made drawable from the safe.

In the present disclosure, a money handling method performed by a money handling apparatus having a safe includes: specifying at least one drawer that is allowed to be drawn out from the safe, from among a plurality of drawers configured to be drawable from the safe, each drawer including one or a plurality of storage units configured to store money therein; and allowing drawing-out of the specified at least one drawer while restricting drawing-out of other drawers, by at least one locking unit configured to restrict drawing-out of each of the plurality of drawers from the safe.

According to the money handling apparatus and the money handling method of the present embodiment, it is possible to limit the number of storage units that can be drawn out from the safe, among the plurality of storage units disposed in the single safe in the money handling apparatus.

As described above, the money handling apparatus and the money handling method according to the present disclosure are useful for allowing only a part of a plurality of storage units disposed in one safe included in the money handling apparatus to be drawn out from the safe.

What is claimed is:

1. A money handling apparatus, comprising:
a safe having a safe door;
a plurality of drawers configured to be drawable from the safe when the safe door is opened, each drawer including one or a plurality of storage units configured to store money therein;
at least one locking unit configured to restrict drawing-out of each of the plurality of drawers from the safe; and
a control unit configured to control the at least one locking unit to put each drawer into either an unlocked state where the drawing-out of the drawer is allowed or a locked state where the drawing-out of the drawer is restricted.

2. The money handling apparatus according to claim 1, wherein the control unit controls the at least one locking unit while the safe door is opened, such that at least one drawer, among the plurality of drawers, is allowed to be drawn out from the safe while other drawers are not allowed to be drawn out from the safe.

3. The money handling apparatus according to claim 1, further comprising:
an information input unit through which information on money handling is inputted to the control unit; and
a memory that stores setting information prepared in advance, the setting information including drawer information that has been prepared for each piece of information to be inputted through the information input unit, and the drawer information indicating at least one drawer to be made drawable from the safe when the each piece of information is inputted through the information input unit, wherein
when the information has been inputted through the information input unit, the control unit specifies, based on the setting information, the at least one drawer to be made drawable and controls the at least one locking unit to allow the specified at least one drawer to be drawn out from the safe.

4. The money handling apparatus according to claim 3, wherein
the information on money handling includes identification information of a user,
the setting information includes the drawer information prepared for each piece of the identification information, and
when the identification information of the user has been inputted through the information input unit, the control unit specifies, based on the setting information, the at least one drawer that can be drawn out by the user having the inputted identification information, and controls the at least one locking unit to allow the specified at least one drawer to be drawn out from the safe.

5. The money handling apparatus according to claim 3, wherein
the information on money handling includes type information indicating a type of the money handling to be performed in the money handling apparatus (10),
the setting information includes the drawer information prepared for each piece of the type information, and
when the type information has been inputted through the information input unit, the control unit specifies, based on the setting information, the at least one drawer that can be drawn out in the money handling whose type is indicated by the inputted type information, and controls the at least one locking unit to allow the specified at least one drawer to be drawn out from the safe.

6. The money handling apparatus according to claim 1, further comprising:
a locking/unlocking unit configured to lock and unlock the safe door; and
an operation unit through which an unlock code for unlocking the safe door by the locking/unlocking unit is inputted, wherein
the operation unit accepts an input of the unlock code on condition that there is the at least one drawer to be made drawable from the safe.

7. A money handling method performed by a money handling apparatus having a safe, the method comprising:
specifying at least one drawer that is allowed to be drawn out from the safe, from among a plurality of drawers configured to be drawable from the safe, each drawer including one or a plurality of storage units configured to store money therein; and
allowing drawing-out of the specified at least one drawer while restricting drawing-out of other drawers, by at least one locking unit configured to restrict drawing-out of each of the plurality of drawers from the safe.
